(19) United States
(12) Patent Application Publication
(10) Pub. No.: US 2023/0398821 A1
(43) Pub. Date: Dec. 14, 2023

(54) Anti-Sway Joint for Trailer

(71) Applicant: Pasq, LLC, Chicago, IL (US)

(72) Inventors: Rod Holmes, Chicago, IL (US); B. Luke Pomranky, Mokena, IL (US)

(21) Appl. No.: 18/334,907

(22) Filed: Jun. 14, 2023

Related U.S. Application Data
(60) Provisional application No. 63/366,366, filed on Jun. 14, 2022.

(51) Int. Cl. B60D 1/30; B62K 27/12; B62K 27/00

(52) U.S. Cl. CPC B60D 1/30; B62K 27/12; B62K 27/006; B60D 2001/003

(57) ABSTRACT

A combination trailer and hitch system for a motorcycle is configured to minimize and/or reduce sway of the trailer during use. The system includes a hitch having a coupler attachable to a trailer to be towed, a second coupler attachable to a motorcycle (or a mounting frame attached to the motorcycle) for towing the trailer, and at least a pair of connector arms pivotably fastened by one end to the first coupler and by an opposite end to the second coupler. The pivotable connections of the connector arms are spaced such that a longitudinal axis of each connector arm converges as they extend toward the rear axle of the motorcycle.

### RELATED APPLICATION

The present disclosure claims the filing priority of U.S. Provisional Application No. 63/366,366, titled “Anti-Sway Joint For Trailer” filed on Jun. 14, 2022. The '366 application is hereby incorporated herein.

### TECHNICAL FIELD OF THE INVENTION

The present invention relates to trailer couplings for motorcycles. More specifically, the invention relates to a motorcycle and trailer coupling which minimizes sway of the trailer during travel.

### BACKGROUND OF THE INVENTION

Conventional couplings for a motorcycle (ebike or other two and three wheel vehicles) to trailer follows the device and methods used for four-wheeled vehicles (e.g., cars, trucks, RVs), which is to say the ball hitch. For example, see U.S. Pat. No. 7,988,178 to Shockley et al., U.S. Pat. No. 10,414,462 to Kernes, and D298,022 to O'Rourke. And, as a variation of the ball hitch, see U.S. Pat. No. 6,921,099 to Hoffmann where the ball and socket are replaced by a pin and hole, respectively. Each provides the same single point connection with a pivot point behind the motorcycle.

These designs suffer from at least one great flaw: they are unable to control trailer sway. This is especially true when the trailer has a single tire. Once the trailer begins to sway, it will continue to over-correct due, in part, to the position of the pivot point.

Until the invention of the present application, these and other problems in the prior art went either unnoticed or unsolved by those skilled in the art. The present invention provides a construction and system which, when in proper use, will outperform prior art devices without sacrificing features or design, style, or affordability.

### SUMMARY OF THE INVENTION

There is disclosed herein an improved trailer and hitch system and assembly for a coupling to a motorcycle, which avoids the disadvantages of prior devices while affording additional structural and operating advantages.

Generally speaking, the disclosed system connects a trailer to a motorcycle for towing, and comprises a trailer coupler for connecting to a trailer to be towed by a motorcycle, a motorcycle coupler for connecting to the motorcycle to tow the trailer, a first connector arm pivotably fastened by one end to the trailer coupling and by an opposite end to the motorcycle coupling, and a second connector arm pivotably fastened by one end to the trailer coupling and by an opposite end to the motorcycle coupling. Preferably, the pivotable connections of the first connector arm and the second connector arm are spaced a first distance on the trailer coupling, and the pivotable connections of the first connector arm and the second connector arm are spaced a second distance on the motorcycle coupling, such that the first spaced apart distance is greater than the second spaced apart distance.

The system may further comprise a rear wheel mounting frame attached to the motorcycle coupler, the rear wheel mounting frame comprising first and second bracket arms, wherein the first and second bracket arms are configured to connect to a rear axle of the motorcycle.

Alternatively, the system may use a mounting frame which connects to the motorcycle coupler and the motorcycle frame.

In the disclosed embodiments, a longitudinal axis of the first connector arm intersects a longitudinal axis of the second connector arm proximate the rear axle of the motorcycle.

In specific embodiments, the system may further comprise a third connector arm pivotably fastened by one end to the first mounting plate and by an opposite end to the second mounting plate, and a fourth connector arm pivotably fastened by one end to the first mounting plate and by an opposite end to the second mounting plate.

Similar to the first and second connector arms, the pivotable connections of the third connector arm and the fourth connector arm are spaced a third distance on the first mounting plate, and the pivotable connections of the third connector arm and the fourth connector arm are spaced a fourth distance on the second mounting plate, and the third spaced apart distance is greater than the fourth spaced apart distance.

Preferably, the system creates a pivot point proximate a rear axle of the motorcycle to help control swaying of the trailer during towing.

Further to the system, a method for minimizing sway of a trailer being towed by a motorcycle is also described. The method comprises coupling the trailer to the motorcycle using at least two double-pivotable connecting arms, configuring the at least two double-pivoting connecting arms such that the trailer pivot point—i.e., a point at which a longitudinal axis of each of the two connecting arms intersect—is located proximate a rear axle of the motorcycle.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a front perspective view of an embodiment of the disclosed motorcycle trailer and hitch system;

FIG. 2 is a rear perspective of the embodiment of FIG. 1;

FIG. 3 is a side view of the embodiment of FIG. 1;

FIG. 4 is a top view of an embodiment of the system showing projected longitudinal axis of each connector arm to a pivot point proximate a rear axle of a motorcycle;

FIG. 5 is a top view of an embodiment of the system similar to FIG. 4 with the trailer coupling plate removed;

FIG. 6 is a side view of the embodiment of FIG. 4;

FIG. 7 is a front perspective view of the embodiment of FIG. 4;

FIG. 8 is top view showing an embodiment of the system coupled to a rear axle of a motorcycle;

FIG. 9 is a close-up, perspective view of an alternate embodiment of the disclosed hitch having two sets of connector arms;

FIG. 10 is a top view of the embodiment of FIG. 9;

FIG. 11 is side view of the embodiment of FIG. 9;

FIG. 12 is another top view of the embodiment of FIG. 9 including an embodiment of the motorcycle mounting frame;

FIG. 13 is a top view illustrating operation of the trailer and hitch system of FIG. 9 moving straight;

FIG. 14 is a top view illustrating operation of the trailer and hitch system of FIG. 9 in a left turn; and

FIG. 15 is a top view illustrating operation of the trailer and hitch system of FIG. 9 in a right turn.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

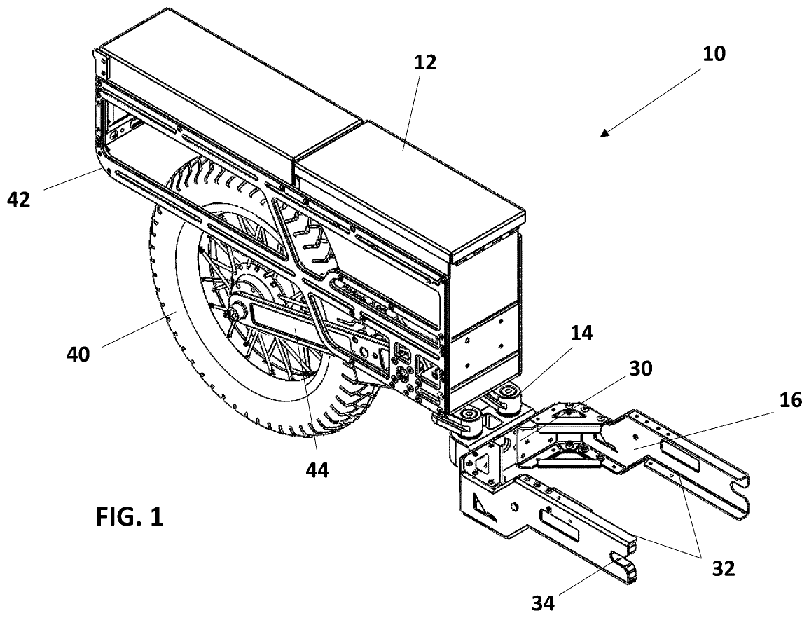

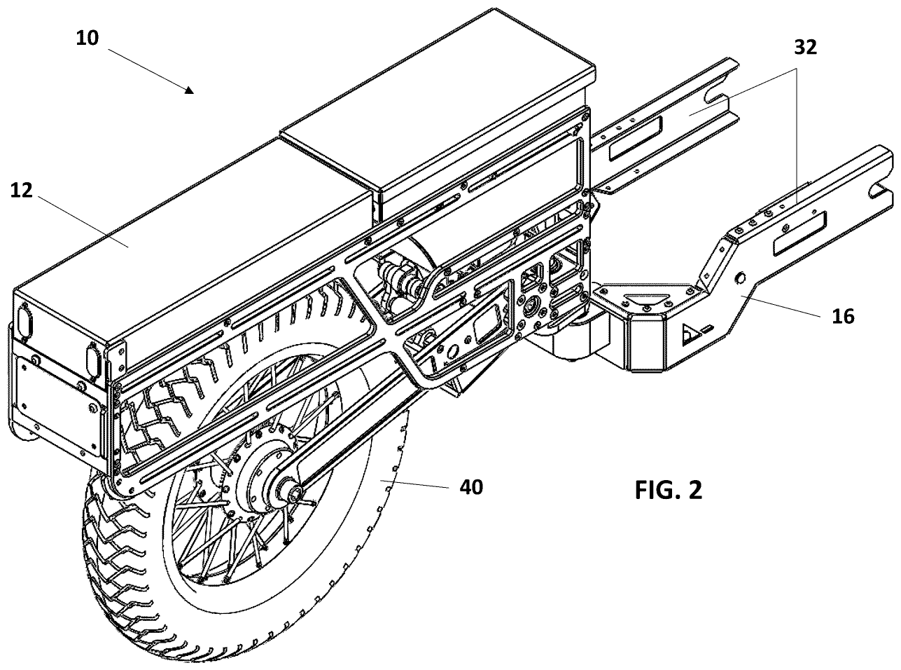

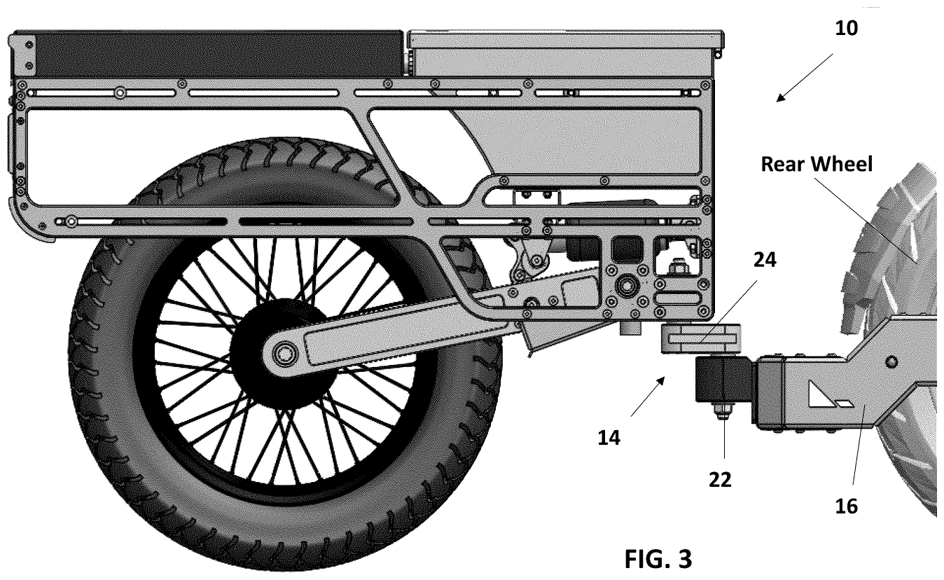

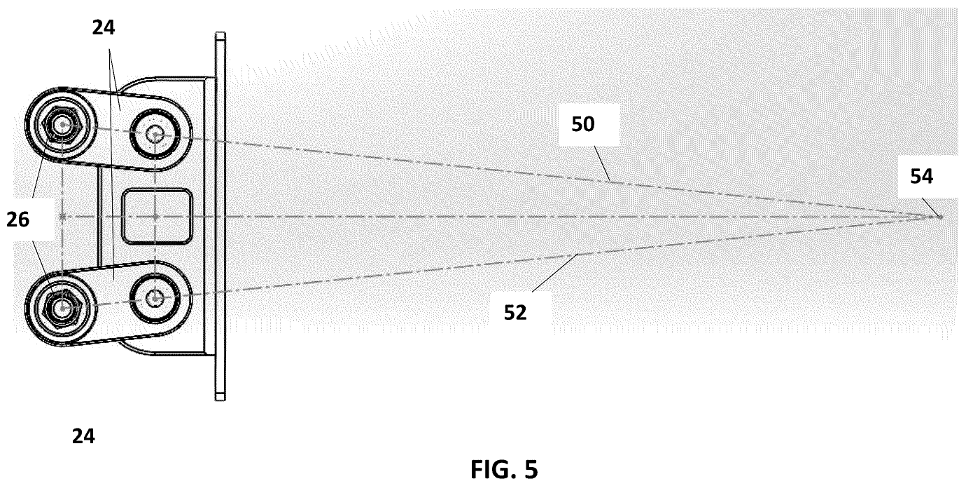

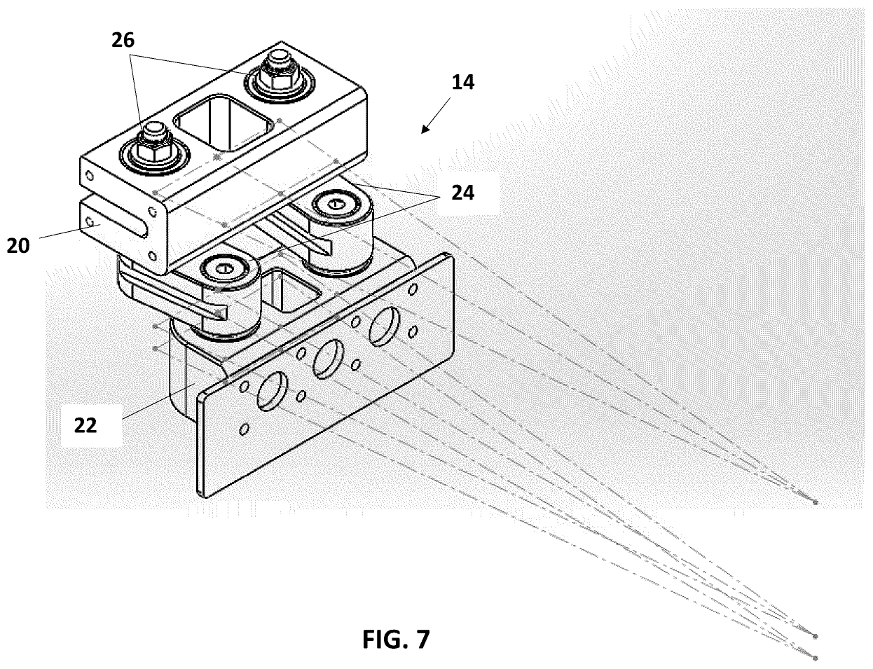

Referring to FIGS. 1-15, there is illustrated at least one embodiment of a trailer and hitch system for a motorcycle, the system generally designated by the numerals 10 and 110. While the particular illustrated trailer and hitch system 10, 110 is shown and described for connection and towing by a motorcycle, it should be understood that the term “motorcycle” is intended to include not only traditional motorcycles, but other non-four-wheel vehicles as well, such as ebikes, scooters, SLINGSHOTS™ (i.e., three-wheeled vehicle), motor-trikes, and track-vehicles, such as snowmobiles. Particularly, those type of non-four wheel vehicles which are capable of traveling at greater speeds where swaying of a trailer would be a significant problem. Further, while all the embodiments illustrated are directed to a complete system 10, other embodiments may include retro-fit kits which can be used to replace existing ball hitch configurations on motorcycle-to-trailer towing systems.

As can be seen in FIGS. 1-3, the illustrated embodiment of the trailer and hitch system 10 comprises a trailer 12, and a hitch 14. Attached to the hitch 14 is a motorcycle mounting frame 16 which connects to the rear axle of a motorcycle. Preferably, the mounting frame 16 can be easily connected to and disconnected from the motorcycle at the axle using a quick-connector (not shown), as is known in the art. The mounting frame 16 comprises a rear plate 30 and two bracket arms 32 which, in use, extend along each side of the rear tire of a motorcycle. A slot 34 is provided in the end of each bracket arm 32 for engaging the rear axle.

As shown, the trailer 12 has a single wheel 40 connected to a frame 42 via a suspension arm 44 on each side of the wheel 40. The trailer 12 illustrated is merely exemplary and can be configured in any suitable manner for connection and towing by a motorcycle.

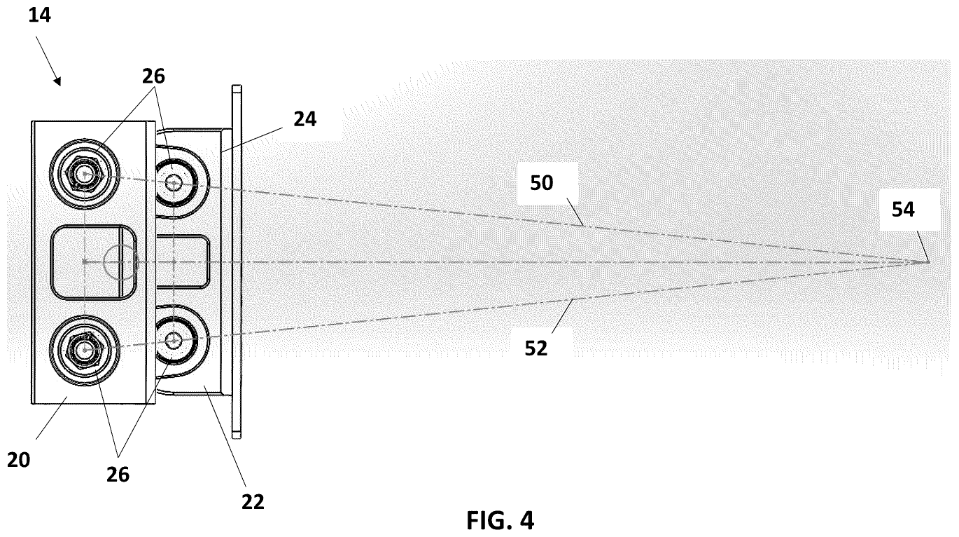

Referring to FIGS. 4-7, the hitch 14 is shown in greater detail. The hitch 14 comprises a trailer coupler 20, a motorcycle coupler 22, and two connector arms 24. While the trailer coupler 20 is preferably connected directly to the trailer 12, the motorcycle coupler 22 is, in the present embodiment, connected to the motorcycle mounting frame 16, which then connects directly to the motorcycle. Any reference to connecting to the motorcycle includes the motorcycle mounting frame 16.

A bolt and collet assembly 26 (four total) is used to attach each arm 24 to the trailer coupler 20 and to the motorcycle coupler 22. In the present embodiment, the connector arms 24 are short to provide better control and tracking. Because the illustrated trailer 12 is particularly narrow, longer connector arms begin to interfere with each other when pivoting and can limit the turning radius of the vehicle and trailer combination. Conversely, if the connector arms are too short, there is not enough clearance for adequate hardware and serviceability is hampered. For these reasons, the connector arms 24 preferably fall within the range of 2″ to 4″ (5.1 to 10.2 cm), measured from center to center on the mounting holes.

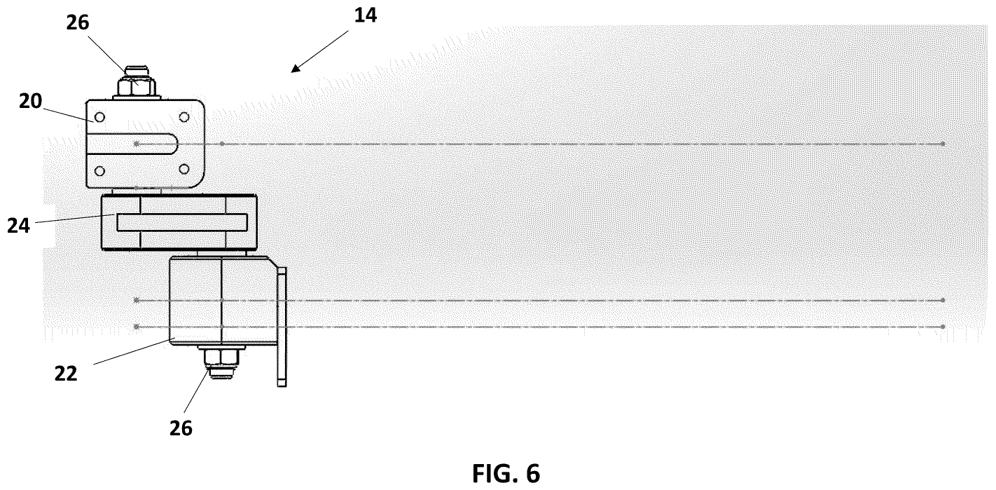

Further, the three components (couplers 20 and 22, and arms 24) are preferably stacked in a configuration as shown in FIG. 6, with the motorcycle coupler 22 at the bottom, the trailer coupler 20 at the top, and the connector arms 24 in the middle. The two connector arms 24 are connected such that the space between the arms 24 on the motorcycle coupler 22 is less than the space between the arms 24 on the trailer coupler 20. This trapezoidal configuration creates two converging longitudinal axes, 50 and 52. The angle at which the axes, 50 and 52, converge creates a pivot point 54 at the rear axle of the connected motorcycle. This optimizes the stability of the trailer 12 through turns, on rough roads, and in adverse weather conditions.

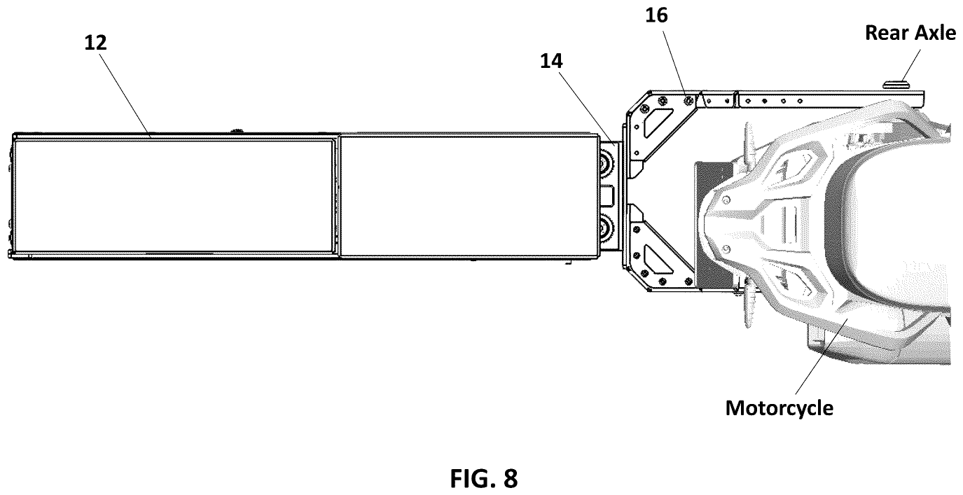

With reference to FIG. 8, the top view shows a slight off-center mounting of the trailer and hitch system 10 relative to the motorcycle. This off-center mounting is necessary with some vehicles due to center-plating. That is, all motorcycles have different dimensions from the center of the rear tire to the leftmost and rightmost parts of the axle. Center-plating is used to put the bracket arms 32 of the mounting frame 16 in an optimal position so they can grab onto the axle adapter (an added part that goes through the rear wheel axle) in a way which places the tire of the trailer 12 in alignment with the tires of the towing motorcycle—i.e., all three tires are in a line. Of course, the necessary offset is going to be different for each vehicle, as would be understood by those of skill in the art.

### Alternate Embodiments

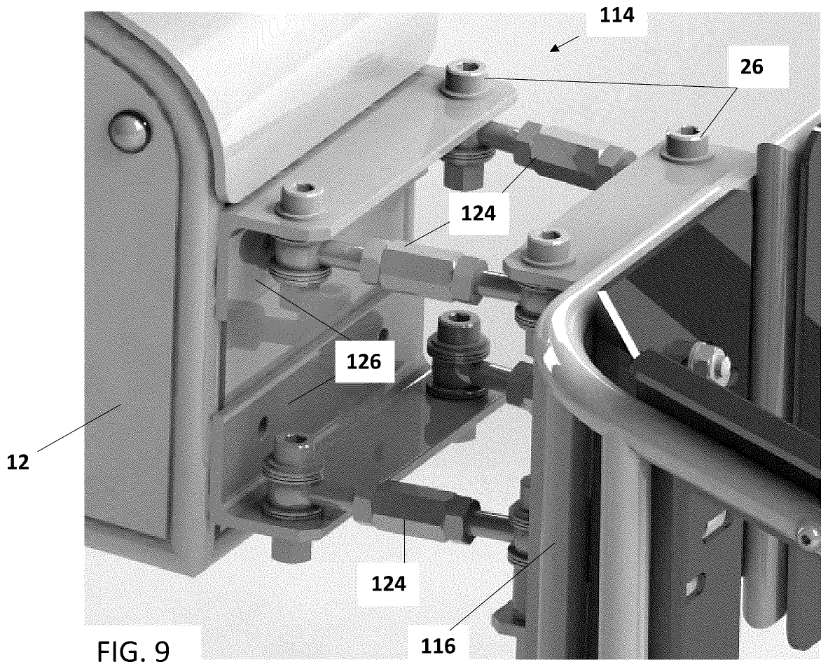

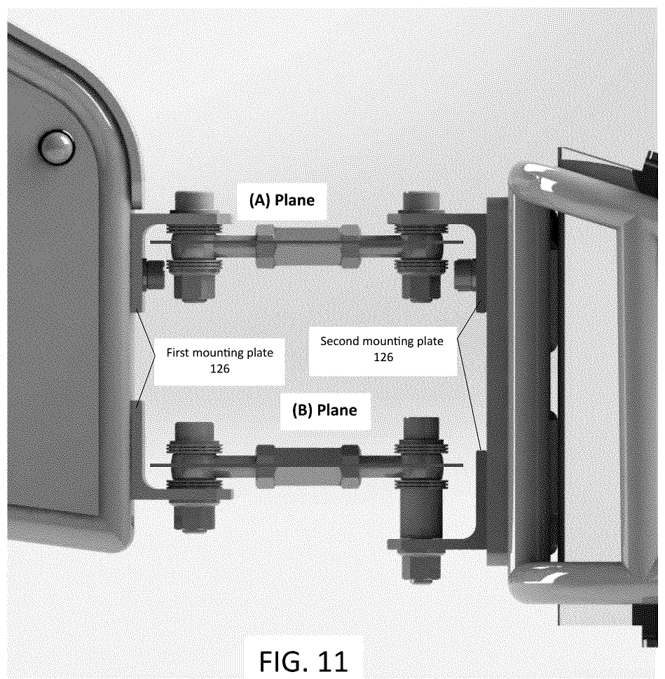

FIGS. 9-12 illustrate an alternate embodiment of the system 110 having two sets of connector arms 124 (four total). The four connector arms 124 are arranged in planar pairs, two on an upper plane (A) and two within a lower plane (B). Mounting plates 126 are used to connect the hitch 114 to the trailer 12 and the motorcycle mounting frame 16. The mounting plates 126 may be a single plate on each side, or two separate pairs of plates which together form a mounting plate for the two planar connector arm pairs, as illustrated in FIG. 11. Additional pairs of connector arms 124 could be used to increase redundancy, if desired.

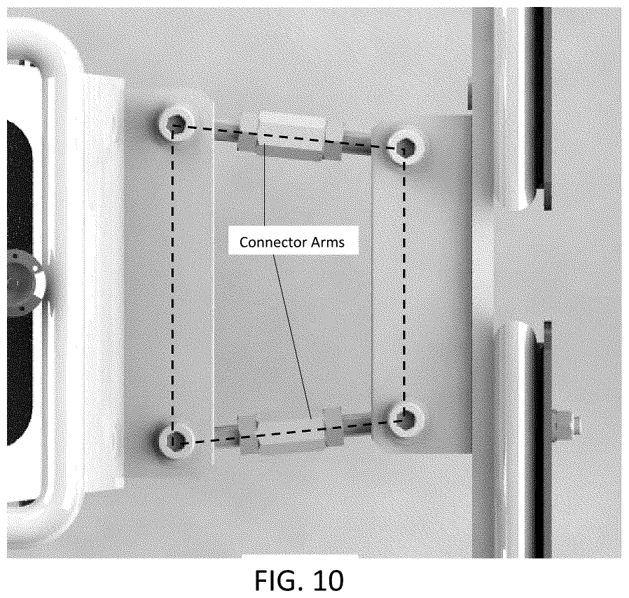

As shown in FIG. 12, as in the first embodiment, the configuration of the connector arms 124 is such that the longitudinal axis of each connector arm 124 tapers inward (see trapezoid of FIG. 10) as it is extended and intersect proximate a rear axle of a towing motorcycle. The intersection of these axes forms the pivot point for the trailer 12. This helps stabilize the trailer 12 over traditional coupling which provides a pivot point a distance behind the rear tire.

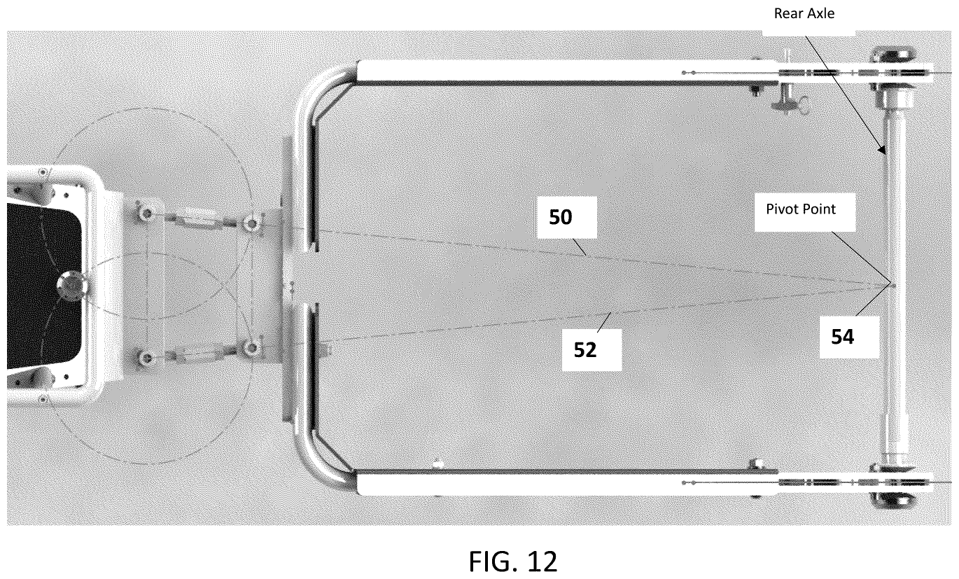

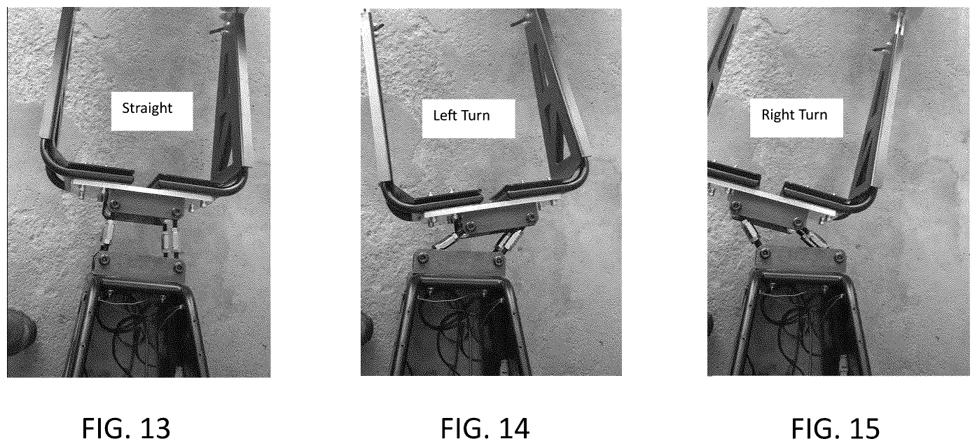

FIGS. 13-15 illustrate how the system 110 would react to straight, left, and right turns, respectively, as it tracks from the rear axle of the motorcycle. As configured, a side pressure on the trailer—such as what might be created in a crosswind—does not cause the trailer to deflect as might happen with a prior art system with the trailer pivoting from behind the rear tire.

In another alternate embodiment, it may be necessary to connect the motorcycle coupler 22, 122 to the frame of the towing motorcycle instead of the rear axle. For example, there may be too much torque or load on the rear wheel of a single swingarm bike. Another example would be where there is no way to attach bracket arms 32 of a mounting frame 16 to the rear axle. In these cases, a mounting frame that bolts directly to the motorcycle frame would be used. The trailer 12 would then attach to the mounting frame, via hitch 14, but may only have one center bracket arm and not two side arms.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A motorcycle trailer hitch comprising:
a trailer coupler for connecting to a trailer to be towed by a motorcycle;
a motorcycle coupler for connecting to the motorcycle to tow the trailer;
a first connector arm pivotably fastened by one end to the trailer coupling and by an opposite end to the motorcycle coupling;
a second connector arm pivotably fastened by one end to the trailer coupling and by an opposite end to the motorcycle coupling;
wherein the pivotable connections of the first connector arm and the second connector arm are spaced a first distance on the trailer coupling, and the pivotable connections of the first connector arm and the second connector arm are spaced a second distance on the motorcycle coupling, and
wherein the first spaced apart distance is greater than the second spaced apart distance.

2. The motorcycle trailer hitch of claim 1, further comprising a rear wheel mounting frame attached to the motorcycle coupler, the rear wheel mounting frame comprising first and second bracket arms, wherein the first and second bracket arms are configured to connect to a rear axle of the motorcycle.

3. The motorcycle trailer hitch of claim 1, further comprising a mounting frame attached to the motorcycle coupler, the mounting frame comprising a bracket arm, wherein the bracket arm is configured to connect to a frame of the motorcycle.

4. The motorcycle trailer hitch of claim 2, wherein a longitudinal axis of the first connector arm intersects a longitudinal axis of the second connector arm proximate the rear axle of the motorcycle.

5. The motorcycle trailer hitch of claim 1, wherein the trailer coupling, the motorcycle coupling, and the first and second connector arms are each on a different plane.

6. The motorcycle trailer hitch of claim 5, wherein the plane of the first and second connector arms is between the plane of the trailer coupler and the plane of the motorcycle coupler.

7. The motorcycle trailer hitch of claim 2, wherein a longitudinal axis of the rear wheel mounting frame is off-center relative to a longitudinal axis of the motorcycle.

8. A combination trailer and hitch system for coupling to a motorcycle, the combination comprising:
a trailer having a body, a single wheel attached to the body via a suspension, and a hitch mounting site;
a hitch comprising:
a trailer coupler for connecting to the hitch mounting site of the trailer;
a motorcycle coupler for connecting to a motorcycle to tow the trailer;
a first connector arm pivotably fastened by one end to the trailer coupling and by an opposite end to the motorcycle coupling;
a second connector arm pivotably fastened by one end to the trailer coupling and by an opposite end to the motorcycle coupling;
wherein the pivotable connections of the first connector arm and the second connector arm are spaced a first distance on the trailer coupling, and the pivotable connections of the first connector arm and the second connector arm are spaced a second distance on the motorcycle coupling, and
wherein the first spaced apart distance is greater than the second spaced apart distance.

9. The combination trailer and hitch system as set forth in claim 8, further comprising a rear wheel mount attached to the motorcycle coupling and comprising first and second arm brackets, wherein the first and second arm brackets are configured to connect to a rear axle of a motorcycle.

10. The combination trailer and hitch system of claim 9, wherein a longitudinal axis of the first connector arm intersects a longitudinal axis of the second connector arm proximate the rear axle of the motorcycle.

11. A system for coupling a trailer to a motorcycle for towing, the system comprising:
a first mounting plate attachable to a trailer to be towed;
a second mounting plate, attachable to a motorcycle for towing the trailer;
a first connector arm pivotably fastened by one end to the first mounting plate and by an opposite end to the second mounting plate; and
a second connector arm pivotably fastened by one end to the first mounting plate and by an opposite end to the second mounting plate;
wherein the pivotable connections of the first connector arm and the second connector arm are spaced a first distance on the first mounting plate, and the pivotable connections of the first connector arm and the second connector arm are spaced a second distance on the second mounting plate, and
wherein the first spaced apart distance is greater than the second spaced apart distance.

12. The system of claim 11, wherein the first connector arm and second connector arm are planar.

13. The system of claim 11, further comprising a third connector arm pivotably fastened by one end to the first mounting plate and by an opposite end to the second mounting plate, and a fourth connector arm pivotably fastened by one end to the first mounting plate and by an opposite end to the second mounting plate.

14. The system of claim 13, wherein the pivotable connections of the third connector arm and the fourth connector arm are spaced a third distance on the first mounting plate, and the pivotable connections of the third connector arm and the fourth connector arm are spaced a fourth distance on the second mounting plate, and the third spaced apart distance is greater than the fourth spaced apart distance.

15. The system of claim 14, wherein a pivot point is created proximate a rear axle of the motorcycle.

16. A method for minimizing sway of a trailer being towed by a motorcycle, the method comprising:
coupling a trailer to a motorcycle using at least two double-pivotable connecting arms;
configuring the at least two double-pivoting connecting arms such that the trailer pivot point is located proximate a rear axle of the motorcycle.

17. The method of claim 16, wherein the at least two double-pivoting connecting arms are positioned to be planar and converging.
